(19) United States
(12) Patent Application Publication
(10) Pub. No.: US 2014/0084100 A1
(43) Pub. Date: Mar. 27, 2014

(54) TORSION SPRING FOR CONTROL UNIT OF CURTAINS

(71) Applicant: YU-TING KAO, TAINAN CITY (TW)

(72) Inventor: YU-TING KAO, TAINAN CITY (TW)

(73) Assignee: UNI-SOLEIL ENT. CO., LTD., TAINAN CITY (TW)

(21) Appl. No.: 13/625,119

(22) Filed: Sep. 24, 2012

(51) Int. Cl. E06B 9/78

(52) U.S. Cl. 242/389

(57) ABSTRACT

A control unit for curtains includes a frame connected with a shaft and a torsion spring is mounted to the shaft. Two extension sections extend from two ends of the torsion spring at an angle. At least one of the two extension sections of the torsion spring has a contact section extending therefrom at an angle. The contact section contacts the end of the protrusion of the socket in a form of face-to-face. By the contact section of the torsion spring, the extension section and the contact section of the torsion spring does not shift to the underside of the protrusion.

### BACKGROUND OF THE INVENTION

1. Field of the Invention

The present invention relates to a torsion spring, and more particularly, to a torsion spring for a control unit of a curtain, the torsion spring is always engaged with the protrusion of the socket.

2. Description of Related Art

The conventional control unit 6 for curtains such as blinds and Roman shades is disclosed in FIGS. 5 and 6, and generally comprises a frame 61 and a tubular member 62 is connected to the center of the frame 61. A torsion spring 63 is mounted to the tubular member 62. A sleeve 64 is mounted to the torsion spring 63 and the tubular member 62. An opening 641 is defined axially in the wall of the sleeve 64 and the two extension sections 631 of the torsion spring 63 are respectively engaged with two insides of the opening 641. A bead-chain wheel 642 is connected to the sleeve 64 and located close to the frame 61. The sleeve 64 is received in a recess 651 of a socket 65. A protrusion 652 extends from the inner periphery of the recess 651 and one of the two extension sections 631 of the torsion spring 63 contacts one of the two ends of the protrusion 652.

The driving shaft of the curtain is connected to the socket 65 and when the bead-chain wheel 642 is rotated, the sleeve 64 is co-rotated with the bead-chain wheel 642. The opening 641 moves the extension section 631 of the torsion spring 63 to release the tubular member 62 and the torsion spring 63 is rotated. The extension section 631 of the torsion spring 63 pushes the protrusion 652 of the socket 65 so that the socket 65 is rotated. Therefore, the driving shaft connected with the socket 65 is rotated to lift or lower the curtain.

It is noted that the curtain is moved by the extension section 631 of the torsion spring 63 pushing the protrusion 652 of the socket 65, such that the driving shaft connected with the socket 65 is rotated to lift or lower the curtain. However, the curtain's weight is heavy along with the larger size curtain used, the force that is applied to the protrusion 652 from the extension section 631 is so significant and the extension section 631 receives the reaction force from the protrusion 652 at the same force as applied to the protrusion 652, so that the extension section 631 of the torsion spring 63 may be forced to shift to the underside of the protrusion 652 as shown in FIG. 7. In other words, the extension section 631 of the torsion spring 63 can no longer pushes the protrusion 652 to rotate the socket 65. The curtain cannot be operated by the control unit 6.

The present invention intends to provide a torsion spring which has a contact section extending from the extension section so as to ensure that the contact section and the extension section are always in contact with the end of the protrusion.

### SUMMARY OF THE INVENTION

The present invention relates to a control unit for curtains and comprises a frame connected with a shaft and a torsion spring is mounted to the shaft. Two extension sections extend from two ends of the torsion spring at an angle. At least one of the two extension sections of torsion spring has a contact section extending therefrom at an angle. A sleeve is mounted to the shaft and the torsion spring. An opening is defined axially through the wall of the sleeve and the two extension sections of the at least one torsion spring contact the opening. A socket has a recess and the shaft, the torsion spring and the sleeve are received in the recess. A protrusion extends from the inner periphery of the recess of the socket. The contact section contacts one of two ends of the protrusion.

By the contact section of the torsion spring, the extension section and the contact section of the torsion spring does not shift to the underside of the protrusion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the control unit of the present invention;

FIG. 2 is a perspective view to show the control unit of the present invention, wherein a section of the sleeve and the shaft are removed;

FIG. 3 is a cross sectional view to show the control unit of the present invention;

FIG. 4 is an exploded view to show the other embodiment of the control unit of the present invention;

FIG. 5 is an exploded view to show the conventional control unit;

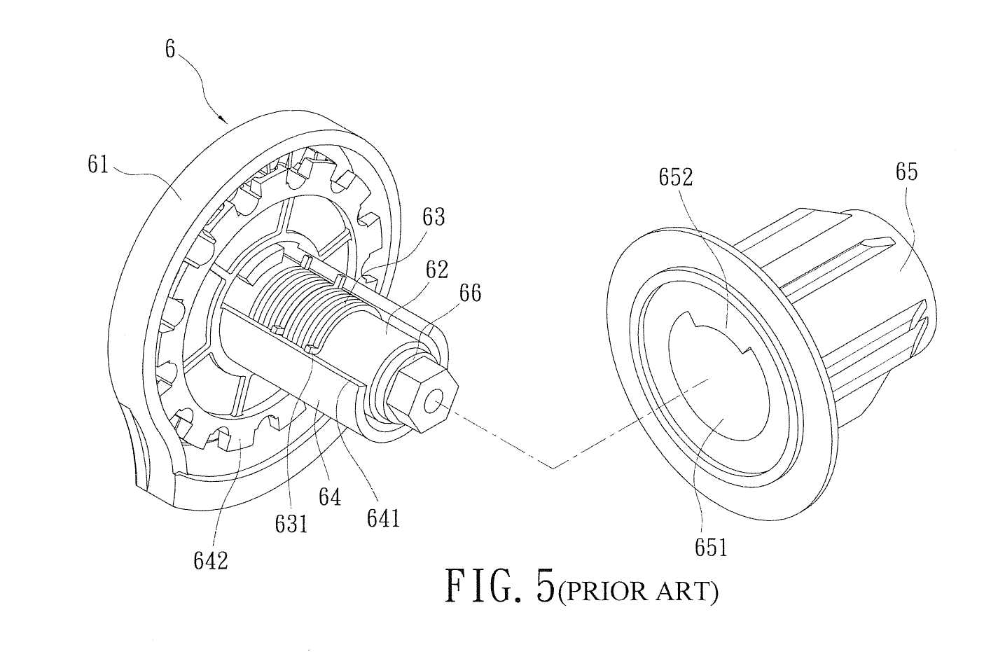

FIG. 6 is a cross sectional view of the conventional control unit, and

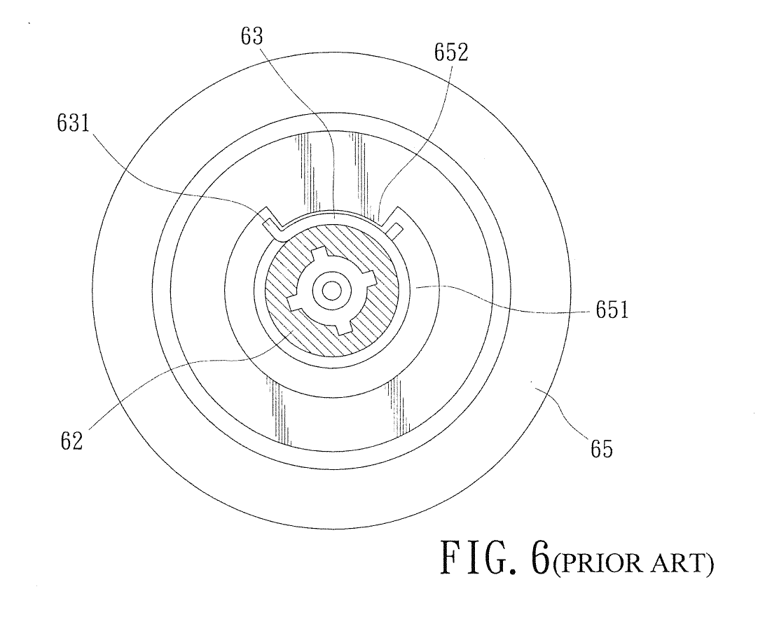

FIG. 7 shows that the extension section of the torsion spring of the conventional control unit moves to the underside of the protrusion.

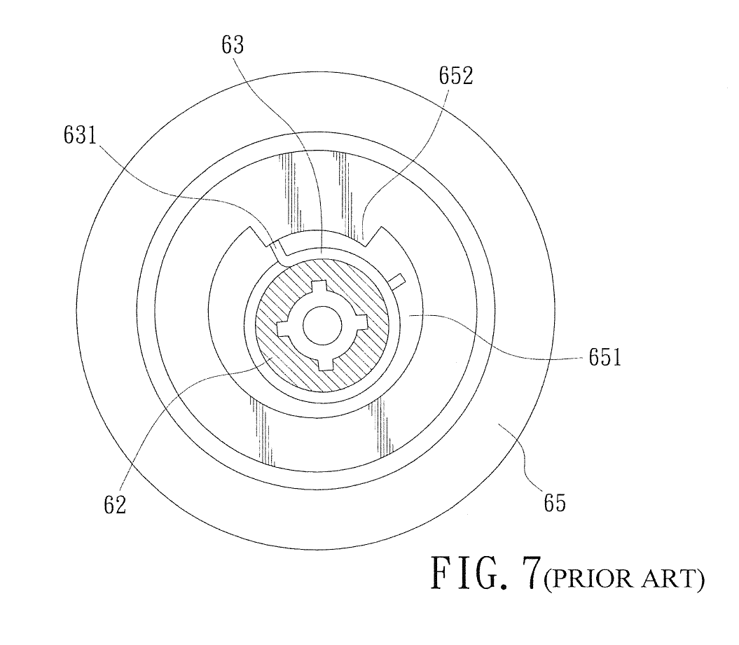

### DETAILED DESCRIPTION OF THE PREFERRED EMBODIMENT

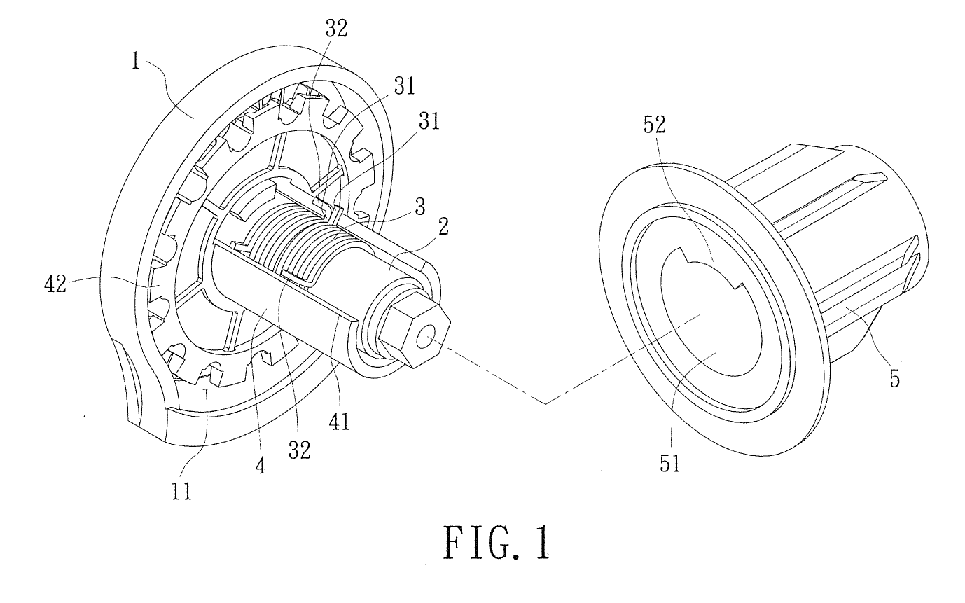

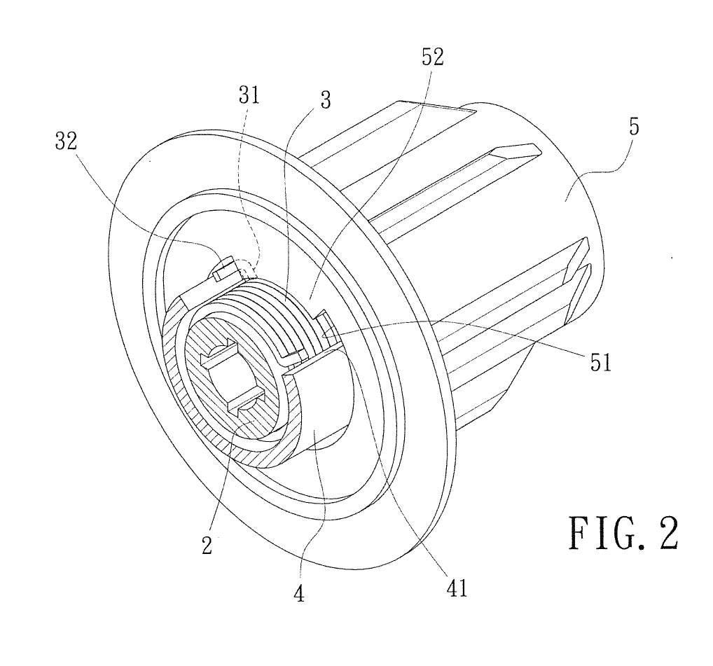

Referring to FIGS. 1 to 3, the control unit of the present invention comprises a frame 1, a shaft 2, a torsion spring 3, a sleeve 4 and a socket 5.

The frame 1 has a reception area 11 defined therein.

The shaft 2 is connected to the frame 1 and the torsion spring 3 is mounted to the shaft 2.

There are two torsion springs 3 mounted to the shaft 2 in this embodiment, two extension sections 31 respectively extend from two ends of each of the two torsion springs 3 at an angle. One of the two extension sections 31 of each of the two torsion springs 3 has a contact section 32 extending perpendicularly therefrom. The contact sections 32 are located in the recess 51 of the socket 5. The recess 51 of the socket 5 has an opening and an inner end, the opening is located close to the frame 1 and the inner end is located away from the frame 1. The contact section 32 of one torsion spring 3 is located adjacent to the extension section 31 without the contact section 32 of the other torsion spring 3. The two torsion directions of the two torsion springs 3 are in opposite to each other.

The sleeve 4 is mounted to the shaft 2 and the torsion springs 3. An opening 41 is defined axially through the wall of the sleeve 4 and the two extension sections 31 and the two contact sections 32 of the two torsion springs 3 contact two insides of the opening 41. The contact sections 32 are parallel to the insides of the opening 41. A bead-chain wheel 42 is connected to the sleeve 4 and is located close to the frame 1, the bead-chain wheel 42 is located in the reception area 11 of the frame 1.

The socket 5 has the recess 51 in one end thereof and the shaft 2, the torsion springs 3 and the sleeve 4 are received in the recess 51. A protrusion 52 extends from the inner periphery of the recess 51 of the socket 5. The contact sections 32 of the two torsion springs 3 located beside the two ends of the protrusion 52. The contact sections 32 of the torsion springs 3 are parallel to the end of the protrusion 52. The contact sections 32 will contact the two ends of the protrusion 52 in form of face-to-face.

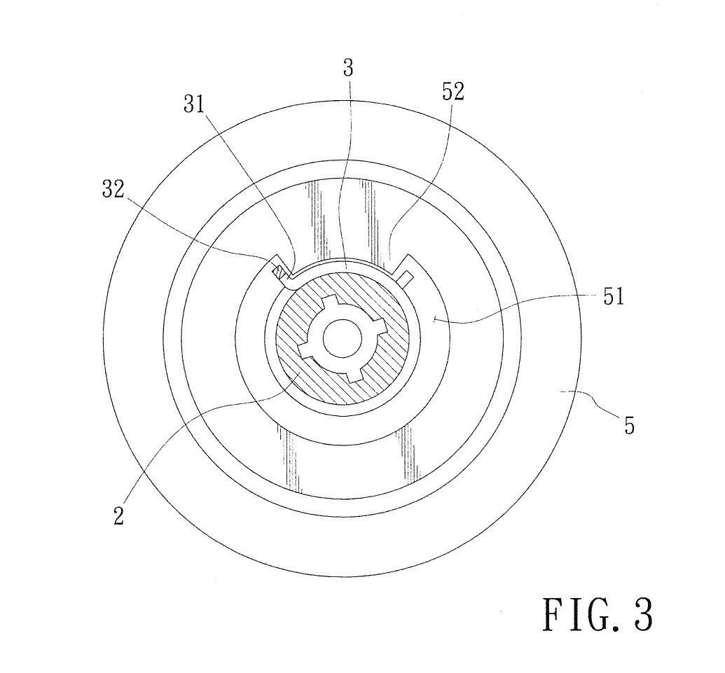

The bead chain is connected to the bead-chain wheel 42 and the diving shaft of the curtain is connected to the socket 5. The curtain fabric is connected to the driving shaft. When the user pulls the bead chain, the bead-chain wheel 42 rotates and the sleeve 4 is rotated with the bead-chain wheel 42. The inside of the opening 41 of the sleeve 4 pushes the extension sections 31 and the contact sections 32, so that the torsion springs 3 are rotated. The extension sections 31 and the contact sections 32 contact the protrusion 52 of the socket 5 as shown in FIG. 3, so as to rotate the socket 5 to drive the driving shaft and to lift or lower the curtain.

Because the inside of the opening 41 and the engaging sections 32 contact to each other by larger contact area, so that when the torsion springs 3 are activated, the contact sections 32 are evenly applied by the force and the user can easily pulls the bead chain to operate the curtain. The contact sections 32 contact the protrusion 52 in form of face-to-face, and the contact section 32 located adjacent to the inner end of the recess 51 is parallel to the end of the protrusion 52 and contacts the protrusion 52 in form of face-to-face, the force applied to the contact section 32 can be evenly spread to the contact section 32, and the contact section 32 is prevented from being shifted to the underside of the protrusion 52.

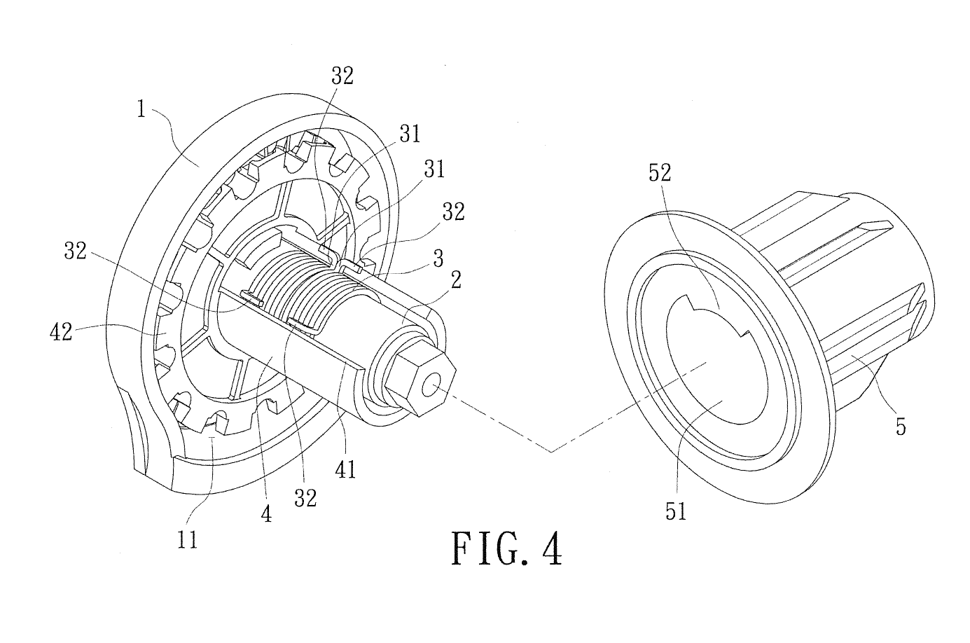

As shown in FIG. 4 which shows the other embodiment of the control unit of the present invention, wherein each of the extension sections 31 of each of the two torsion springs 3 has the contact section 32 extending perpendicular therefrom. The two respective contact sections 32 of the two torsion springs 3 are located adjacent to each other and the two adjacent contact sections 32 extend away from each other. The other two respective contact sections 32 of the two torsion springs 3 extend toward each other. By the specific arrangement, the user pulls the bead-chain wheel 42 easily and the curtain is lifted or lowered more precisely and smoothly. The extension sections 31 and the contact sections 32 are prevented from being shifted to the underside of the protrusion 52.

While we have shown and described the embodiment in accordance with the present invention, it should be clear to those skilled in the art that further embodiments may be made without departing from the scope of the present invention.

What is claimed is:

1. A control unit for curtains, comprising:
a frame connected with a shaft and at least one torsion spring mounted to the shaft, two extension sections extending from two ends of the at least one torsion spring at an angle, at least one of the two extension sections of at least one torsion spring having a contact section extending therefrom at an angle;
a sleeve mounted to the shaft and the at least one torsion spring, an opening defined axially through a wall of the sleeve and the two extension sections of the at least one torsion spring contacting the opening, and
a socket having a recess and the shaft, the at least one torsion spring and the sleeve being received in the recess, a protrusion extending from an inner periphery of the recess of the socket, the contact section contacting one of two ends of the protrusion.

2. The control unit as claimed in claim 1, wherein the contact section of the at least one torsion spring is perpendicular to the extension section, the contact section is parallel to the end of the protrusion.

3. The control unit as claimed in claim 1, wherein the recess of the socket has an opening and an inner end, the opening is located close to the frame and the inner end is located away from the frame, the contact section is located at the extension section that is located adjacent to the inner end of the recess.

4. The control unit as claimed in claim 3, wherein the contact section of the at least one torsion spring is perpendicular to the extension section, the contact section is parallel to the end of the protrusion.

5. The control unit as claimed in claim 3, wherein there are two torsion springs and two torsion directions of the two torsion springs are in opposite to each other, the two respective contact sections of the two torsion springs are located adjacent to each other.

6. The control unit as claimed in claim 5, wherein the contact section of the at least one torsion spring is perpendicular to the extension section, the contact section is parallel to the end of the protrusion.

7. A control unit for curtains, comprising:
a frame connected with a shaft and two torsion springs mounted to the shaft, two extension sections respectively extending from two ends of each of the two torsion springs at an angle, each of the two extension sections of each of the two torsion springs having a contact section extending therefrom at an angle;
a sleeve mounted to the shaft and the torsion springs, an opening defined axially through a wall of the sleeve and the contact sections of the two torsion springs contacting the opening in form of face-to-face, and
a socket having a recess and the shaft, the torsion springs and the sleeve being received in the recess, a protrusion extending from an inner periphery of the recess of the socket, the contact sections contacting one of two ends of the protrusion in form of face-to-face.

8. The control unit as claimed in claim 7, wherein the two respective contact sections of each of the two torsion springs extend in opposite directions.

9. The control unit as claimed in claim 7, wherein two torsion directions of the two torsion springs are in opposite to each other, the two respective contact sections of the two torsion springs are located adjacent to each other and extend away from each other, the other two respective contact sections of the two torsion springs extend toward each other.
